(19) United States
(12) Patent Application Publication
(10) Pub. No.: US 2009/0136089 A1
(43) Pub. Date: May 28, 2009

(54) 3D inspection of an object using x-rays

(76) Inventor: Satpal Singh, Potomac, MD (US)

Correspondence Address: SATPAL SINGH, 10704 MORNING FIELD DRIVE, POTOMAC, MD, 20854, US

(21) Appl. No.: 11/898,259

(22) Filed: Sep. 11, 2007

(51) Int. Cl. G06T 7/00

(52) U.S. Cl. 382/103

(57) ABSTRACT

A method is presented for a 3D inspection of an object or bag in order to check for explosives or contraband. The method is applicable to Computed Tomography, Laminography or any other method that can be used to produce images of slices through the object. According to this method, it is not necessary to reconstruct the slice image with a high resolution as is required for visual display, but it is sufficient to reconstruct the image at only a sample or a set of points or pixels that are sparsely distributed within the reconstructed slice. The properties of the object are then analyzed only at these sparsely distributed pixels within the slice to make a determination for the presence or absence of explosives or contraband. This process of image reconstruction and analysis is repeated over several slices spaced through the volume of the object. In another embodiment of this invention, the set of points or pixels at which the image is reconstructed are offset spatially with respect to the set of pixels in the adjacent or neighboring slice. This invention greatly reduces the computational burden, hence simplifies the hardware and software design, speeds up the scanning process and allows for a more complete and uniform inspection of the entire volume of the object.

### CROSS REFERENCE TO RELATED APPLICATIONS

This patent application is related to a co-pending U.S. application Ser. No. 11/399,443, “A Laminographic System for 3D Imaging and Inspection” (Satpal Singh), the contents of which are incorporated herein in their entirety by reference.

### BACKGROUND OF THE INVENTION

1. Field of the Invention

This invention relates to a 3D inspection of an object using x-rays, for example for detection of explosives or contraband in a package or baggage.

2. Description of the Related Art

Conventional baggage scanners generate a 2D image of the bag or object being scanned, they lack the 3D capability and are incapable of effectively checking for explosives.

To overcome the above limitation of the conventional scanners, Computed Tomography (CT) systems were adapted from the medical world to scan for explosives in packages or baggage. CT though very effective, is a very complex system with a rotating gantry, is extremely slow, very bulky, very expensive, very power hungry that needs heavy duty wiring, not portable, and hence has seen only a very limited use.

To overcome some of above limitations of CT, in recent years, there has been a growing interest in multi view systems, where a baggage or object is scanned from different angles to build a 3D image of an object. Examples of such systems are as described in U.S. Pat. No. 6,088,423 (Krug, et al.), Annis (U.S. Pat. No. 7,221,732 B1) and Singh (U.S. patent application Ser. No. 11/399,443). Krug's method (U.S. Pat. No. 6,088,423) uses at least three x-ray beams which are perpendicular to the direction of the motion. Annis' method (U.S. Pat. No. 7,221,732 B1) uses several beams that are non orthogonal to the direction of the motion of object and uses “L” shaped detector arrays with one segment of the “L” in each of the detector arrays being parallel and arranged perpendicular to the direction of motion. Singh's method (U.S. patent application Ser. No. 11/399,443) however arranges its “L” shaped detectors such that none of its segments are parallel nor perpendicular to the direction of motion thereby producing a lower and uniform distortion in the reconstructed image of the object.

One problem encountered with the above 3D type systems is of how to generate rapidly a 3D data of the scanned volume of the object. One way to overcome this is to use extensive electronics for processing and computations which drive up the complexity and cost of the system. Another problem is that once the 3D data has been generated, how to quickly inspect this data to ascertain if there are explosives in the scanned baggage or not. This invention overcomes the above problems as stated next in the objectives.

### OBJECTS OF THE INVENTION

It is, accordingly, an object of the invention to provide a fast method of inspecting 3D volume of a scanned object or baggage, for example as required for the detection of explosives or contraband. It is also an object of the invention, to minimize the use of computational electronics and keep the cost of the system low.

It is also an objective of the invention to be applicable to any 3D imaging technique, whether it is Computed Axial Tomography that usually has a rotating gantry, or a multi-view system, or a Laminographic system, or a Tomosysnthesis system.

These and other objects will become apparent in the description that follows.

### SUMMARY OF THE INVENTION

This invention utilizes the fact that bombs and contraband to be detected have a finite size and therefore it is not necessary to reconstruct the image of the object in as detail as would be required for visual display of image, but only over a sparse set of points or pixels or voxels and analyzing at these points for the presence of explosives or contraband. This method of analyzing over only a sparse set of points reduces computational burden by orders of magnitude, greatly simply hardware and electronics design, and greatly speed up the scan time.

In one embodiment of this invention, the object or package is placed on a conveyor belt and moved through multiple fan beams of x-ray radiation, each fan beam being received and detected by a linear array of x-ray detectors. These fan beams are non parallel, that is they intercept the scanned object at different angles to produce multiple views of the objects from different angles. The data from these multiple views is then used according to the methods of back projection or any other suitable method of reconstruction well known to a person skilled in the art, to generate an image of a slice through the object. The novelty of this invention is that to save the computation time and complexity, the reconstruction is carried out only over a coarse grid. For example the slice image can be reconstructed over a grid of 256 by 256 pixels, or 65,536 pixels, however, the coarse grid according to this invention may be set only to 8 by 16 or 128 pixels. The idea behind this scheme is that explosives or bombs have a finite dimension which is usually larger than the fine grid of 256 by 256 required for visual display of even a low resolution image. For a bag with a cross section of 10 inches by 25 inches, a 256 by 256 grid would divide it into pixel size of 0.04 inches by 0.1 inch, where as any real bomb will have dimensions much larger than that. It is therefore adequate to only sample the cross section slice through the bag only over a spatial sampling distance larger than the minimum bomb size. This method of reconstructing only at a few sampled locations of the cross sectional slice saves the computation time and complexity by a huge factor, in the above example by a factor of 65,536/128=512.

In another embodiment of the invention, the computational time can be further slashed by further reducing the number of sample points over which the reconstruction is carried out, for example, reconstructing over a grid of only 4 by 8 or a total of only 32 pixels. Compared to the original 256 by 256 grid, this results in a saving by a huge factor of 65,536/32=2048. However since the reconstructed grid of 4 by 8 is now very coarse, and there is a likelihood of missing the bomb, the reconstruction of the next cross sectional slice is carried out with the 4 by 8 grid offset diagonally to nearest diagonal pixel on a 16 by 32 grid. Reconstructing over 4 such diagonally offset consecutive or neighboring slices one can sample the object by a 16 by 32 grid which would be adequate for most small bags and parcels. The computational complexity is now much smaller and can be easily handled by personal computers. The idea behind reconstruction over offset slices is that a real bomb will have dimensions not only over a cross sectional slice, but also have sufficient dimensions of length.

The method of this invention is not limited to just the multiple fan beam architecture described above, but also to conventional Computed Tomography where a set of detectors and a x-ray source spin around the object. According to the method of this invention, it is not necessary to reconstruct the slice image over a fine grid, but only over a sparse set of points spatially distributed over the expanse of reconstructed slice.

These and several other embodiments, objects and advantages will be apparent to one skilled in the art. The description herein should be considered illustrative only and not limiting or restricting the scope of invention, the scope being indicated by the claims.

### BRIEF DESCRIPTION OF THE DRAWINGS

FIG. 1 shows an embodiment of the invention with two x-ray sources and two sets of detectors used for 3D inspection of the object volume.

FIG. 2 shows object 80 and two neighboring planes of image reconstruction, 85 and 86 separated by a distance d.

FIG. 3a shows plane 85 of image reconstruction with an imaginary grid G1 superimposed. Grid G1 is shown with 4 horizontal lines and 8 vertical lines, the intersection of these lines define 32 points at which the image is reconstructed.

FIG. 3b shows plane 86 of image reconstruction with an imaginary grid G1 moved diagonally to location G2. The grid points of G2 define the points in 86 at which the 3D image reconstruction is performed. Compared to FIG. 3a, the image reconstruction points in 86 are diagonally offset compared to the reconstruction points for image plane 85.

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

The technique described herein is applicable to any 3D imaging system, examples of which are, Computed Tomography implemented usually with a rotating gantry, Laminography, Tomosynthesis, and multi-view systems. For the sake of illustrating the application of the method of this invention, a multi-view system as described in U.S. application Ser. No. 11/399,443 (Singh) is described.

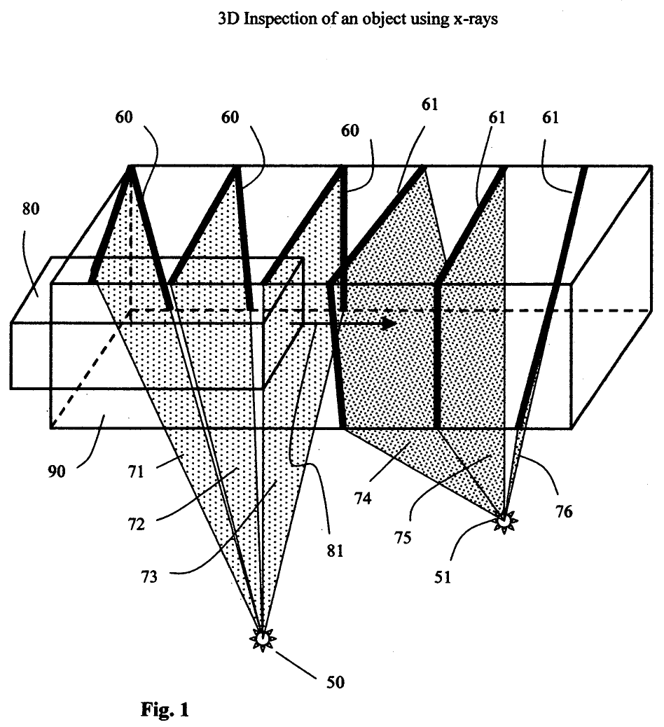

As shown in FIG. 1, an object or bag 80 is transported through a tunnel 90 in the direction of the arrow 81. Not shown in this figure to avoid the clutter are the conveyor belt, the motors and the transport mechanism and other details which are well known to a person skilled in the field.

As illustrated in FIG. 1, when the object moves through the tunnel 90, it first intercepts radiation from the first set of three fan beams 71, 72 and 73 from a first x-ray source 50 and received by a first set of detectors 60. As the object 80 moves further through the tunnel, it intercepts a second set of three additional fan beams 74, 75 and 76 from a second x-ray source 51 and received by a second set of detectors 61. The detectors are “L” shaped linear arrays, each array composed of numerous small detectors often referred to as pixels. These detectors can be of any of the several types that are well known. Not shown in this figure are the electronics that senses, amplifies, digitizes and processes the signal coming from the detectors and ships the data to a computer for further processing and display. Again, for the sake of clarity, ordinary details of a data storage memory, computer, display, High Voltage generator, x-ray fan beam collimators and control for the X-ray tube have been omitted.

The two x-ray sources, 50 and 51 would ordinarily be placed such that beam axes are at 90 degrees or some suitably large angle so that the object 80 can be viewed from wider angles, this is preferred as it leads to higher definition image. Also, only six detector sets in total have been shown in FIG. 1 for the sake of clarity, more can be used to generate a higher definition image. Further, as few as one detector set can be used for each x-ray source. Also, more than two x-ray sources can be used.

In normal mode of operation, as the object 80 is moved through the tunnel 90, the x-ray radiation detected by detector arrays 60 and 61 is amplified, digitized and stored in electronic memory which can reside in a computer connected to the system of FIG. 1. From the data stored in the memory, a 3D image of the object 80 can be reconstructed. The methods of laminography for generating cross sectional images of layers through an object have been described in U.S. Pat. No. 5,583,904 (Adams), U.S. Pat. No. 3,818,220 (Richards), U.S. Pat. No. 3,499,146 (Richards), and U.S. application Ser. No. 11/399,443 (Singh). As the methods of 3D image reconstruction are well known to a person skilled in the art, they will not be described any further here.

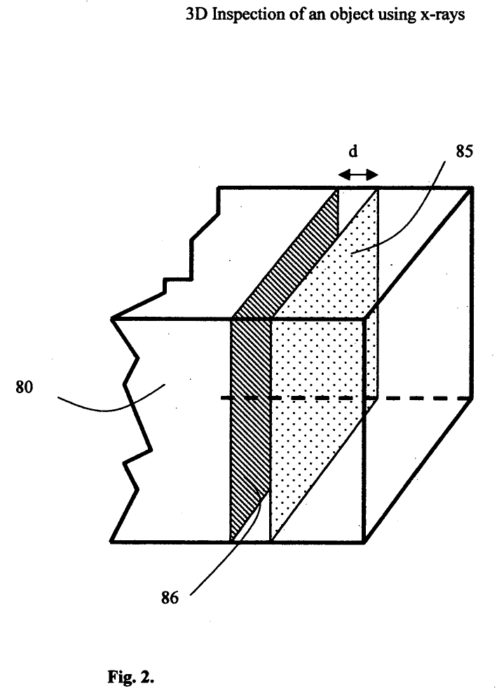

FIG. 2 shows two consecutive or neighboring planes or slices or regions 85 and 86 separated by a distance “d” intersecting the object 80 over which the image reconstruction can be done. For the purposes of image reconstruction, analysis and display, the image is usually divided into rectangular pixels often by a grid of 256 by 256 or more. The image at each of these pixels can be reconstructed by simply delaying the signals from each of the detector suitably and summing them up, this is the method of laminography described in U.S. application Ser. No. 11/399,443 (Singh) and well known to a person skilled in art. If there are 256 by 256 or 65,536 pixels, then a lot of computations need to be done which the computer may not be able to handle in a short time between the sampling interval of the detectors, and may require several dedicated micro-computing devices built into the electronics. However, by the method of this invention, for the purpose of 3D inspection of a volume to check for explosives or contraband, it is not necessary to reconstruct the slice image over such fine grid, but only at fewer grid points or at a set of pixels sparsely distributed within the reconstructed image region or slice. In other words it is sufficient to sample the slice through an object at only a few points or pixels spatially distributed over the slice. The justification behind using a smaller grid is that any real bomb will likely have dimensions much larger than the minimum resolvable dimension of the system which is usually a millimeter or less, where as it is difficult to imagine a bomb of size even as small as a few millimeters.

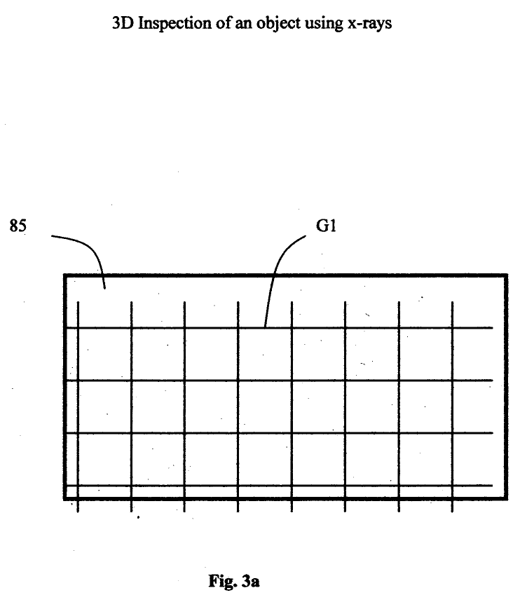

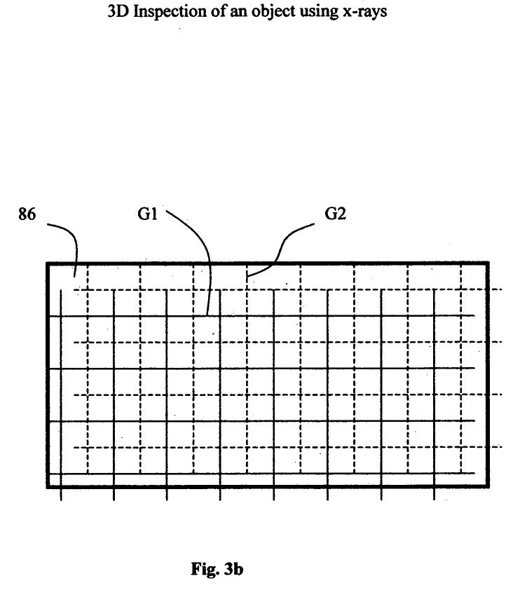

For the purpose of illustration, FIG. 3a shows the image plane 85 with a grid G1 superimposed over it to indicate the points of image reconstruction. As shown, the grid G1 comprises of 4 horizontal and 8 vertical lines for a total of 4×8=32 grid points or pixels over which the image is reconstructed. If the bomb or contraband is of a size greater than the spacing of the grid points, then the analysis of the image plane 85 at only 32 grid points or pixels can result in the detection of the bomb.

In order to detect bombs of size smaller than the spacing of a 4 by 8 grid, the method of this invention offsets the grid diagonally when reconstructing the image in the adjacent or neighboring plane 86 as shown in FIG. 3b. The new location of the grid is now shown by the dotted grid G2 which has been diagonally offset from the old location G1. The two neighboring planes 85 and 86 now together sample the object volume over a finer grid of 8 horizontal lines by 16 vertical lines thereby allowing detection of bombs of half the size detectable by the coarse grid shown in FIG. 3a.

To further improve the detection of smaller bombs, image reconstruction of four consecutive or neighboring planes with the sampling grid offset by one fourth the diagonal of original grid can be implemented. The justification for this is that any real bomb is likely to have some finite dimension along the length of the object which is likely to be larger than the minimum distance “d” between neighboring planes shown in FIG. 3b, where the distance “d” in a typical baggage screening system using approximately 1-2 mm size detector elements is of the order of a millimeter. Thus by this method of offsetting the grid four times in four consecutive neighboring image planes, the object volume can be sampled over a grid of 16 horizontal lines and 32 vertical lines which could be sufficient to check for explosives in small bags of 4 to 12 inches height and 12 to 24 inches wide.

In order to improve the reliability of bomb detection, the original grid size can be increased from 4 by 8 to 8 by 16 or higher.

The method of sampling saves on the computational requirement by a big factor. For example if the image plane were to be sampled by a 256 by 256 grid, then 65,536 sets of computations would be needed. But now with a 4 by 8 grid and offsetting over four consecutive image planes, one needs to perform only 32 sets computation per plane. This amounts to a saving of 65536/32=2048.

If a grid size of 8 by 16 or 128 grid points were used, then the savings in computation is by a factor of 65536/128=512.

As a result of huge computational savings as discussed above, it is now easy to use personal computers for the image reconstruction and analysis for bomb or contraband detection. This greatly simplifies the complexity of the electronics and reduces the cost.

It should be noted that the above technique can be applied to computed tomography systems with a rotating gantry too. Instead of computing the image of a slice over a fine grid, one need to compute the image over only a coarse grid, and offset the grid between successive or neighboring slices.

It should also be noted that it is not necessary to offset the grid between successive slices or image planes if the computer is powerful enough to handle computations associated with a suitably large grid.

It should also be pointed out that in another embodiment, the reconstructed image slice can be inclined to better detect thin plastic sheet like explosives which may be missed when the reconstructed slices are horizontal or vertical and the sheet like explosive or contraband is stacked in horizontal or vertical layers in a bag.

In yet another embodiment, the set of pixels or sampling points at which the image is reconstructed need not lie on a grid formed by horizontal and vertical lines, but randomly distributed within each grid, or in some other predetermined way. This way, it would be easy to detect a sheet plastic which could go undetected with a coarse rectilinear grid.

As is well known to the person skilled in art, that dual energy x-ray imaging is usually employed and the ratios of the absorption at the two energies can be used to compute the effective atomic number. The 3D reconstruction can be performed for each of the two energies, and at the sample or grid points, the ratios computed to determine the atomic numbers. Further knowing the absorption which gives the density information, a determination of whether the explosives are present or not can be made.

In yet another embodiment, data from one or more line scans can be analyzed for effective atomic numbers and density and suspect regions identified. Then additional sampling points could be placed or the existing sampling points moved to lie inside the regions of suspect. Thus fewer sampling points could be judiciously used to effectively inspect an object.

It should be noted that the sample grid points or pixels at which the image is reconstructed, need not lie on a plane but could lie in a region, but for the ease of understanding, planar regions or slices have been used in the foregoing discussion.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

1. A method of inspecting three dimensional volume of an object comprising the steps of:
generating radiation using a radiation source;
moving said object relative to said radiation;
using detectors to detect said radiation after it has passed through said object;
recording data from said detectors;
saving said data in a memory;
reconstructing an image of said object at a set of pixels sparsely spaced within a region intersecting said object;
repeatedly reconstructing images of said object over a plurality of regions spatially spread over the volume of said object.

2. The method of claim 1 wherein the step of repeatedly reconstructing images includes spatially offsetting the pixels in one region with respect to the pixels in the neighboring region.

3. The method of claim 1 further comprising the step of:
analyzing the reconstructed image to determine the characteristics of the object.

4. The method of claim 2 further comprising the step of:
analyzing the reconstructed image to determine the characteristics of the object.

5. The method of claim 3 wherein said radiation source is a x-ray source, and the step of analyzing comprises of using dual energy x-rays to measure the atomic number and density at each of said pixels in order to check for the presence of explosive or contraband.

6. The method of claim 4 wherein said radiation source is a x-ray source, and the step of analyzing comprises of using dual energy x-rays to measure the atomic number and density at each of said pixels in order to check for the presence of explosive or contraband.

7. An apparatus for inspecting three dimensional volume of an object comprising of:
a radiation source to generate radiation;
a means of moving said object relative to said radiation;
detectors to detect said radiation after it has passed through said object;
means to record data from said detectors;
means to store said data in memory;
a computer to reconstruct an image of said object at a set of pixels sparsely spaced within a region intersecting said object, and further to repeatedly reconstruct images over a plurality of regions spatially spread over the volume of said object.
